(19) United States
(12) Patent Application Publication
(10) Pub. No.: US 2018/0112889 A1
(43) Pub. Date: Apr. 26, 2018

(54) Air-Conditioning Condensate Drain Cleaning Apparatus

(71) Applicants: Stephen Barker, Center Point, AL (US); Michael Faught, Bell, FL (US)

(72) Inventors: Stephen Barker, Center Point, AL (US); Michael Faught, Bell, FL (US)

(21) Appl. No.: 15/791,639

(22) Filed: Oct. 24, 2017

Related U.S. Application Data
(60) Provisional application No. 62/411,904, filed on Oct. 24, 2016.

(51) Int. Cl. F24F 13/22; B08B 9/032

(52) U.S. Cl. CPC F24F 13/222; F24F 2221/225; F24F 2013/227; B08B 9/0325

(57) ABSTRACT

An air-conditioning condensate drain cleaning apparatus is provided. The apparatus includes a housing configured to suspend a condensate drain line cleaning fluid container therein, and a fluid dispensing unit configured to connect the cleaning fluid container to an air-conditioning condensate drain pipe and selectively control the rate at which the cleaning fluid is transferred from the cleaning fluid container to the condensate drain pipe. The fluid dispensing unit includes an elongated tube for transferring a fluid, a drip chamber for viewing the fluid, and a flow regulation clamp configured to control the rate at which the fluid is transferred from the cleaning fluid container to the condensate drain pipe. The housing includes a support member for suspending the cleaning fluid container therein, an elongated slot for viewing the cleaning fluid container, and a pair of apertures and protrusions for removably mounting the front portion to the rear portion.

### CROSS REFERENCE TO RELATED APPLICATIONS

This application claims the benefit of U.S. Provisional Application No. 62/411,904 filed on Oct. 24, 2016. The above identified patent application is herein incorporated by reference in its entirety to provide continuity of disclosure.

### BACKGROUND OF THE INVENTION

The present invention relates to air-conditioning systems. More specifically, the present invention relates to an air-conditioning condensate drain cleaning apparatus including a suspended housing attachable to an air-conditioning condensate drain pipe that is configured to automatically transfer cleaning fluid from the housing to the condensate drain at a controlled flow rate via a flow regulation clamp.

Every year millions of dollars are spent to repair the damage done from clogged and overflowing condensate drain lines and pans. The average air-conditioning unit produces between five and eight gallons a day of condensate when in operation. If the drain line is clogged, it does not take long to overflow the drain pan and cause considerable damage to flooring, ceiling, carpet, as well as possible damage to adjacent housing units. There also can be significant repair costs incurred from mold and mildew damage. This damage often is not covered by insurance.

The key to preventing the condensate drain line from clogging or overflowing is having the drain lines treated on a regular basis with white vinegar, bleach, or some other cleaning fluid. However, it can be difficult to apply the treatment on a regularly scheduled basis. For instance, a significant amount of individuals or families have second homes for investment or vacation properties. However, since they are second homes, the owner or owners are typically not around all that often. This absentee ownership adds to the problem of scheduled maintenance, and makes it more difficult to detect a problem before it can cause any damage. Moreover, a large portion of the world's population lives within 150 kilometers of a coastline. In the United States, more than fifty percent of the population lives within 50 miles of the oceans, and since 1970 there have been approximately 2000 homes per day erected in coastal areas. This means that there is an ever-increasing number of homes which are subjected to high humidity and need algae protection for their air-conditioner condensate drain lines.

Prior art devices for dealing with the algae build-up in the condensate drain lines of the air-conditioning unit have several limitations. For example, prior art devices do not provide the convenience of a device which includes a housing and fluid dispensing mechanism that is configured to receive an external cleaning fluid container and connect to the container and a PVC drain pipe, respectively, so as to establish a fluid communication between the PVC drain pipe and the cleaning fluids within the container. Furthermore, these prior art devices are unable to selectively control the rate at which the cleaning fluid is transferred from the container to the PVC drain pipe.

Therefore, there exists a need for an air-conditioning condensate drain cleaning apparatus suitable for receiving and containing an external cleaning fluid container, connecting the container to an air-conditioning condensate drain pipe, and selectively controlling the rate at which the cleaning fluid is transferred from the container to the drain pipe.

### SUMMARY OF THE INVENTION

In view of the foregoing disadvantages inherent in the known types of cleaning apparatus for air-conditioning condensate drain lines now present in the prior art, the present invention provides an air-conditioning condensate drain cleaning apparatus wherein the same can be utilized for providing convenience for the user when preventing algae build-up and growth in their air-conditioning condensate drain lines.

In one example of the present invention, the air-conditioning condensate drain pipe cleaning apparatus includes a housing configured to removably receive and suspend a cleaning fluid container therein, and further includes a fluid dispensing unit configured to transfer fluids from the cleaning fluid container to a condensate drain pipe. The fluid dispensing unit includes an elongated tube having a first end configured to connect to a mouth of the cleaning fluid container, a second end configured to connect to an inlet of a condensate drain pipe, a drip chamber for providing an area in which to observe and confirm that the fluid dispensing unit is transferring fluids from the cleaning fluid container to the condensate drain pipe, and a flow regulation clamp configured to control the rate at which fluid from cleaning fluid container is transferred from the cleaning fluid container to the condensate drain pipe.

The housing includes a planar support member, a rear portion, a front portion, a top portion, a base portion, and an interior volume. An opening disposed on the planar support member is configured to removably receive a neck of a cleaning fluid container therethrough for suspending the container within the interior volume of the housing. A rear wall disposed on the rear portion is configured to removably receive the planar support member, and includes a pair of opposing longitudinally extending sidewalls configured to support the planar support member perpendicularly relative to the rear wall. An elongated slot disposed on the front portion extends longitudinally from an upper end of the front portion to a lower end of the front portion. A plurality of apertures disposed on the rear wall are configured to removably receive a fastener therethrough for mounting the rear portion to a structure. A plurality of second apertures disposed on the rear wall are configured to receive a plurality of protruding members extending radially outwardly from a perimeter edge of the planar support member. An inwardly extending shelf disposed on each of the pair of opposing longitudinally extending sidewalls is configured to support the planar support member perpendicularly relative to the rear wall when the planar support member is attached to the rear wall. A pair of apertures are disposed on the top portion and are configured to removably receive a pair of protrusions disposed on an edge of an upper end of the rear wall of the rear portion for mounting the front portion to the rear portion.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective phantom view of the air-conditioning condensate drain cleaning apparatus in use according to one embodiment of the present invention.

FIG. 2 shows an exploded view of the housing of the air-conditioning condensate drain cleaning apparatus according to one embodiment of the present invention.

FIG. 3 shows an exploded view of the housing of the air-conditioning condensate drain cleaning apparatus according to an alternative embodiment of the present invention.

### DETAILED DESCRIPTION OF THE INVENTION

Reference is made herein to the attached drawings. Like reference numerals are used throughout the drawings to depict like or similar elements of the air-conditioning condensate drain cleaning apparatus. The figures are intended for representative purposes only and should not be considered to be limiting in any respect.

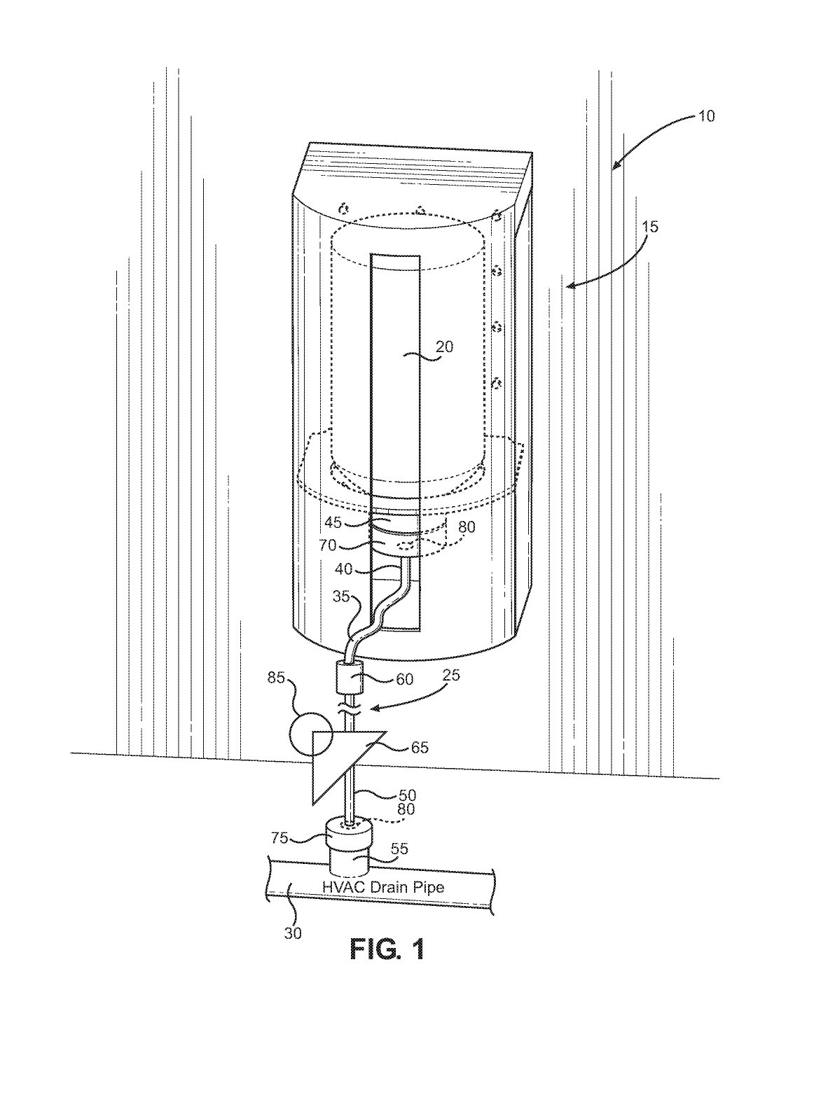

Referring now to FIG. 1, there is shown a perspective phantom view of the air-conditioning condensate drain cleaning apparatus in use according to one embodiment of the present invention. The present invention provides an air-conditioning condensate drain cleaning apparatus 10 configured to receive, contain, and suspend an external condensate drain line cleaning fluid container 20, such as container of white vinegar or bleach, connect the cleaning fluid container 20 to an air-conditioning condensate drain pipe 30, and selectively control the rate at which the cleaning fluid is transferred from the cleaning fluid container 20 to the condensate drain pipe 30. The air-conditioning condensate drain cleaning apparatus 10 comprises a housing 15 configured to removably receive and suspend the condensate drain pipe cleaning fluid container 20 therein, and a fluid dispensing unit 25 configured to transfer the fluids from within the cleaning fluid container 20 to the condensate drain pipe 30.

The fluid dispensing unit 25 comprises an elongated tube 35 having a first end 40 configured to connect to a mouth 45 of the cleaning fluid container 20, a second end 50 configured to connect to an inlet 55 of the condensate drain pipe 30, a drip chamber 60 for providing an area in which to observe and confirm that the fluid dispensing unit 25 is in fact transferring fluids from the cleaning fluid container 20 to the condensate drain pipe 30, and a flow regulation clamp 65 configured to control the rate at which fluid from the cleaning fluid container 20 is transferred from the cleaning fluid container 20 to the condensate drain pipe 30. In the depicted embodiment, the elongated tube 35 is transparent, such that a user may see through the elongated tube 35 in order to confirm that fluid is flowing therethrough.

The first end 40 includes a first cap 70 for removably attaching the fluid dispensing unit 25 to the mouth 45 of the cleaning fluid container 20. In the depicted embodiment, the first cap 70 is a flexible snap-fit cap configured to removably secure to the mouth 45 of the cleaning fluid container 20 via a snap-fit grasp, or friction-fit grasp. In alternative embodiments, the first cap 70 includes a threaded cap for threadably engaging the mouth 45 of the cleaning fluid container 20. The second end 50 includes a second cap 75 for removably attaching the fluid dispensing unit 25 to the inlet 55 of the condensate drain pipe 30. In the depicted embodiment, the second cap 75 is a flexible snap-fit cap configured to removably secure to the inlet 55 of the condensate drain pipe 30 via a snap-fit grasp, or friction-fit grasp. In alternative embodiments, the second cap 75 includes a threaded cap for threadably engaging the inlet 55 of the condensate drain pipe 30. Each of the first and second caps 70, 75 include an orifice 80 in fluid communication with the first and second ends 40, 50, respectively, of the elongated tube 35, such that when attached to the mouth 45 of the cleaning fluid container 20 and the inlet 55 of the condensate drain pipe 30, fluids may be transferred from the cleaning fluid container 20 through the elongated tube 35 to the condensate drain pipe 30.

The flow regulation clamp 65 is coupled to the elongated tube 35, such that the flow regulation clamp 65 can constrict and narrow the diameter of the elongated tube 35 so as to regulate the flow rate of a fluid therethrough. In the depicted embodiment, the flow regulation clamp 65 includes a flow regulation dial 85 rotatably coupled to the flow regulation clamp 65. Manual rotation of the flow regulation dial 85 in a first direction squeezes the elongated tube 35, narrowing the diameter of the elongated tube 35 and decreasing the flow rate of a fluid through the elongated tube 35, and thereby decreasing the rate at which the air-conditioning condensate drain cleaning apparatus 10 transfers fluid to the condensate drain pipe 30 and cleans the condensate drain pipe 30. Manual rotation of the flow regulation dial 85 in a second direction releases the elongated tube 35, broadening the diameter of the elongated tube 35 and increasing the flow rate of a fluid through the elongated tube 35, and thereby increasing the rate at which the air-conditioning condensate drain cleaning apparatus 10 transfers fluid to the condensate drain pipe 30 and cleans the condensate drain pipe 30. In another embodiment, however, the flow regulation clamp 65 comprises a roller clamp for manually adjusting the flow rate of a fluid through the elongated tube 35. In alternative embodiments, the flow regulation clamp 65 comprises an electronic clamp for electronically adjusting the flow rate of a fluid through the elongated tube 35.

The drip chamber 60 is disposed between the first end 40 of the elongated tube 35 and the flow regulation clamp 65. The drip chamber 60 defines an area along a longitudinal length of the elongated tube 35 that includes a larger diameter than a diameter of the elongated tube 35, so as to enable a user to view fluid flowing through the longitudinal length of elongated tube 35. The drip chamber 60 includes a transparent material, so as to enable observation of a fluid dripping therein.

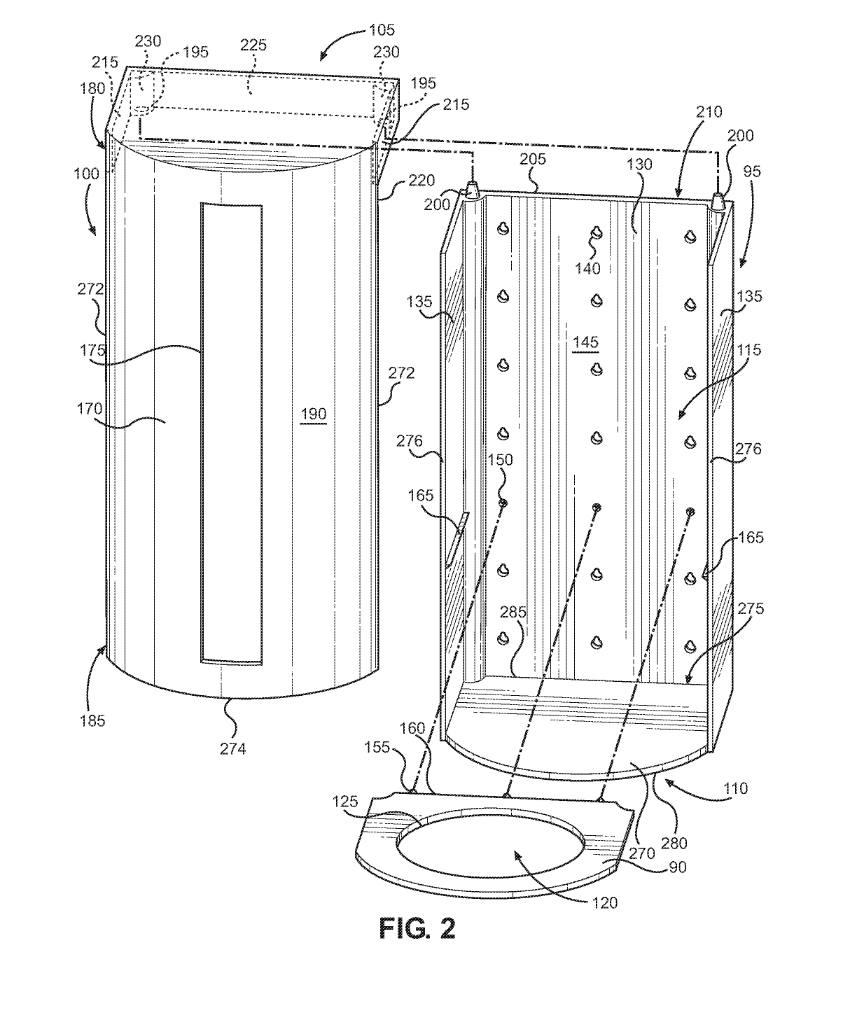

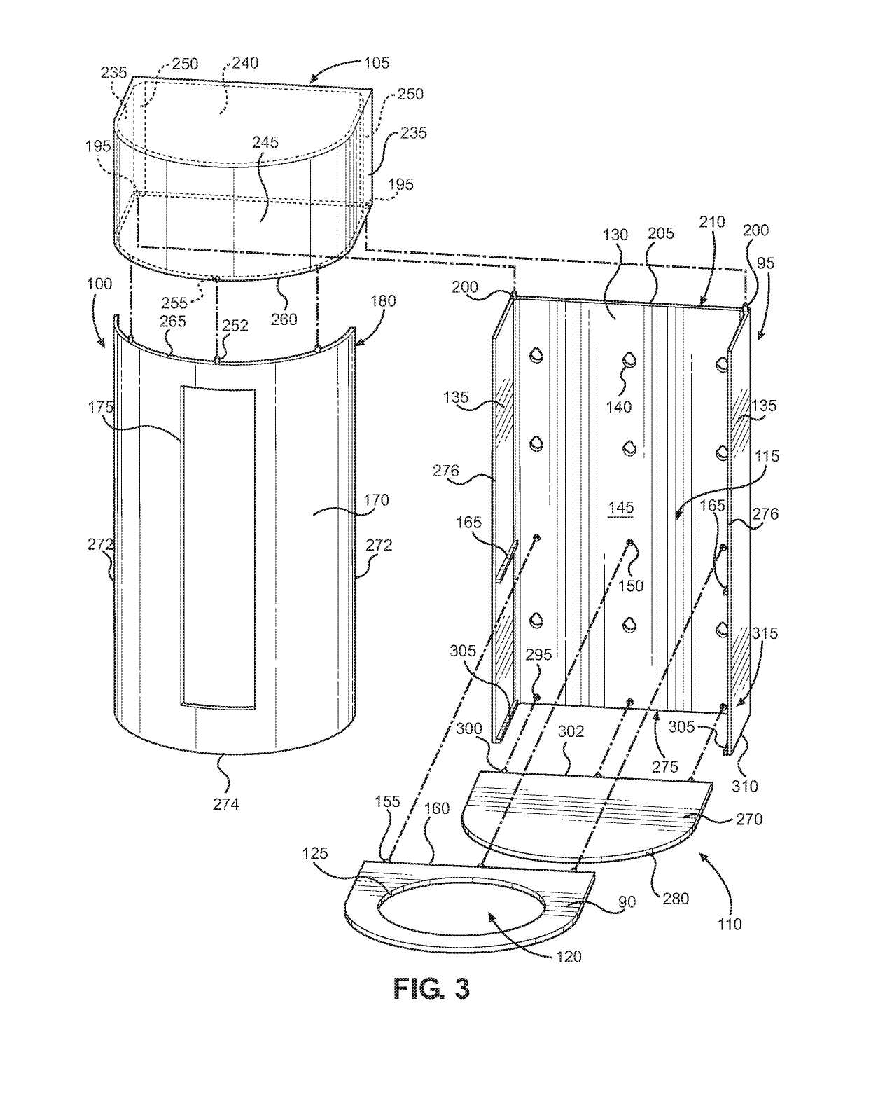

Referring now to FIGS. 2 and 3, there is shown an exploded view of the housing of the air-conditioning condensate drain cleaning apparatus according to one embodiment of the present invention, and an exploded view of the housing of the air-conditioning condensate drain cleaning apparatus according to a second embodiment of the present invention, respectively. The housing 15 includes a planar support member 90, a rear portion 95, a front portion 100, a top portion 105, a base portion 110, and an interior volume 115. The planar support member 90 includes a planar frame including a circular opening 120 configured to removably receive a cleaning fluid container therethrough, such that a perimeter edge 125 of the circular opening 120 can removably receive the neck of the cleaning fluid container, as shown in FIG. 1, and suspend the cleaning fluid container within the interior volume 115 of the housing 15.

The rear portion 95 includes a rear wall 130 configured to removably receive the planar support member 90 and a pair of opposing longitudinally extending sidewalls 135 configured to support the planar support member 90 perpendicularly relative to the rear wall 130. The rear wall 130 includes a plurality of first apertures 140 configured to receive a fastener, such as a screw, anchor, or bolt, therethrough for mounting the rear portion 95 to a structure, such as a wall of a home, office, or other building. The plurality of first apertures 140 are arranged in a grid-like pattern, which includes horizontal columns and vertical rows spanning substantially the entire upper surface 145 of the rear wall 130. The plurality of first apertures 140 provide a user alternative areas on the rear wall 130 of the rear portion 95 in which to insert a fastener and secure the rear portion 95 to a structure. In this way, the user can adjust the housing 15 along a wall of a structure as desired and not have to worry about aligning the housing 15 along the wall in a specific manner so as to capture a stud of the structure when mounting the housing 15.

The rear wall 130 includes a plurality of second apertures 150 configured to removably receive a plurality of protruding members 155 extending radially outwardly from an outer perimeter edge 160 of the planar support member 90. The pair of opposing longitudinally extending sidewalls 135 each include an inwardly extending shelf 165, i.e., a shelf extending into the interior volume 115 of the housing 15, that is disposed beneath a longitudinal axis of the plurality of second apertures 150. The inwardly extending shelves 165 are configured to support the planar support member 90 perpendicularly relative to the rear wall 130 when the plurality of protruding members 155 of the planar support member 90 are inserted into the plurality of second apertures 150 of the rear wall 130.

The front portion 100 includes an arcuate frame 170 having an elongated slot 175 extending longitudinally from an upper end 180 of the front portion 100 to a lower end 185 of the front portion 100. The elongated slot 175 extends substantially the entire length of the upper surface 190 of the arcuate frame 170 so as to allow visibility into the entirety of the interior volume 115 of the housing 15. In this way, when a cleaning fluid container is suspended therein, a user can look through the elongated slot 175 and determine the quantity of fluid remaining in the cleaning fluid container.

The top portion 105 includes a pair of apertures 195 configured to removably receive a pair of protrusions 200 disposed on an edge 205 of an upper end 210 of the rear wall 130 of the rear portion 95. In this way, the front portion 95 is removably mountable onto the rear portion 95.

In a first embodiment, the top portion 105 includes a pair of laterally extending sidewalls 215 directly affixed to edges 220 of an upper end 180 of the front portion 100, and a longitudinally extending sidewall 225, as shown in FIG. 2. The pair of apertures 195 are disposed between corners 230 formed at intersections of the longitudinally extending sidewall 225 and the pair of laterally extending sidewalls 215. The laterally extending sidewalls 215 correspond in length and width to the pair of opposing longitudinally extending sidewalls 135 of the rear portion 95.

In a second embodiment, the top portion 105 includes a pair of laterally extending sidewalls 235 and a longitudinally extending sidewall 240 opposing an arcuate sidewall 245, as shown in FIG. 3. The pair of apertures 195 are disposed between corners 250 formed at intersections of the longitudinally extending sidewall 240 and the pair of laterally extending sidewalls 235. The laterally extending sidewalls 235 correspond in length and width to the pair of opposing longitudinally extending sidewalls 135 of the rear portion 95. The arcuate sidewall 245 includes a second plurality of apertures 255 disposed on an edge 260 of the arcuate sidewall 245 that are configured to removably receive a plurality of protrusions 252 extending upwardly from an upper edge 265 of the upper end 180 of the front portion 100. In this way, the top portion 105 is configured to removably secure the front portion 100 and rear portion 95 to each other.

The base portion 110 includes a planar member 270 extending perpendicularly from a lower end 275 of the rear wall 130 of the rear portion 95. The base portion includes an arcuate edge 280 corresponding to the arch of the arcuate frame 170 of the front portion 100. When the front portion 100 is mounted onto the rear portion 95, the side edges 272 of the front portion 110 and the lower edge 274 of the front portion 100 abut the side edges 276 of the pair of opposing longitudinally extending sidewalls 135 and the arcuate edge 280 of the base portion 110, respectively, thereby enclosing the interior volume 115 of the housing 15.

In a first embodiment, the base portion 110 is directly affixed to an edge 285 of the lower end 275 of the rear wall 130 of the rear portion 95, as shown in FIG. 2.

In a second embodiment, the rear wall 130 includes a plurality of third apertures 295 disposed adjacent the edge 285 of the lower end 275 thereof that are configured to removably receive a plurality of second protruding members 300 disposed on the base portion 110, as shown in FIG. 3. The plurality of second protruding members 300 extend radially outwardly from a perimeter edge 302 of the base portion 110 that is opposite the arcuate edge 280 of the base portion 110. In this way, the rear wall 130 may removably receive the base portion 110. In this embodiment, the pair of opposing longitudinally extending sidewalls 135 of the rear portion 95 each include a second inwardly extending shelf 305, i.e., extending into the interior volume 115 of the housing 115 that is disposed beneath a longitudinal axis of the plurality of third apertures 295. The second inwardly extending shelves 305 are disposed on an edge 310 of a lower end 315 of the pair of opposing longitudinally extending sidewalls 135. In this way, the second inwardly extending shelves 305 are configured to support the base portion 110 perpendicularly relative to the rear wall 130 when the plurality of protruding members 300 of the base portion 110 are inserted into the plurality of third apertures 295 of the rear wall 130.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A condensate drain cleaning apparatus, comprising:
a housing configured to removably receive and suspend a cleaning fluid container therein, the housing including a planar support member, a rear portion, a front portion, a top portion, a base portion, and an interior volume;
a fluid dispensing unit configured to transfer fluids from the cleaning fluid container to a condensate drain pipe, the fluid dispensing unit including an elongated tube having a first end configured to connect to a mouth of the cleaning fluid container, a second end configured to connect to an inlet of a condensate drain pipe, a drip chamber, and a flow regulation clamp configured to control the rate at which cleaning fluid of the cleaning fluid container is transferred from the cleaning fluid container to the condensate drain pipe;
the planar support member including an opening configured to removably receive a neck of a cleaning fluid container therethrough for suspending the cleaning fluid container within the interior volume of the housing;
the rear portion including a rear wall configured to removably receive the planar support member, and a pair of opposing longitudinally extending sidewalls configured to support the planar support member perpendicularly relative to the rear wall;
the front portion including an elongated slot extending longitudinally from an upper end of the front portion to a lower end of the front portion;
wherein the front portion is removably mountable onto the rear portion.

2) The condensate drain cleaning apparatus of claim 1, wherein the rear wall includes a plurality of apertures configured to receive a fastener therethrough for mounting the rear portion to a structure, the plurality of apertures arranged in a grid pattern including horizontal columns and vertical rows, such that the plurality of apertures provide a variety of alternative areas on the rear wall in which to secure the rear portion to the structure.

3) The condensate drain cleaning apparatus of claim 1, wherein the rear wall includes a plurality of second apertures configured to receive a plurality of protruding members extending radially outwardly from a perimeter edge of the planar support member.

4) The condensate drain cleaning apparatus of claim 1, wherein the pair of opposing longitudinally extending sidewalls of the rear wall each include an inwardly extending shelf configured to support the planar support member perpendicularly relative to the rear wall when the planar support member is attached to the rear wall.

5) The condensate drain cleaning apparatus of claim 1, wherein the top portion includes a pair of apertures configured to removably receive a pair of protrusions disposed on an edge of an upper end of the rear wall of the rear portion.

6) The condensate drain cleaning apparatus of claim 5, wherein the top portion includes a pair of laterally extending sidewalls directly affixed to edges of an upper end of the front portion, and a longitudinally extending sidewall, the pair of apertures disposed between corners formed at intersections of the longitudinally extending sidewalls and the pair of laterally extending sidewalls, the laterally extending sidewalls corresponding to the pair of opposing longitudinally extending sidewalls of the rear portion.

7) The condensate drain cleaning apparatus of claim 6, wherein the base portion includes a planar base member directly affixed to a lower end of the rear portion.

8) The condensate drain cleaning apparatus of claim 5, wherein the top portion includes a pair of laterally extending sidewalls, and a longitudinally extending sidewall opposing an arcuate sidewall, the pair of apertures disposed between corners formed at intersections of the longitudinally extending sidewall and the pair of laterally extending sidewalls, the laterally extending sidewalls corresponding to the pair of opposing longitudinally extending sidewalls of the rear portion, a second plurality of apertures disposed on an edge of the arcuate sidewall, the second plurality of apertures configured to removably receive a plurality of protrusions extending upwardly from an edge of the upper end of the front portion.

9) The condensate drain cleaning apparatus of claim 8, wherein the rear wall includes a plurality of third apertures disposed on a lower end thereof;
wherein the base portion includes a planar member including a plurality of protruding members extending radially outwardly from a perimeter edge thereof;
wherein the plurality of third apertures are configured to removably receive the plurality of protruding members, so as to removably secure the base portion to the rear wall.

10) The condensate drain cleaning apparatus of claim 9, wherein the pair of opposing longitudinally extending sidewalls of the rear wall each include a second inwardly extending shelf disposed on the lower end thereof beneath a longitudinal axis of the plurality of third apertures, the second inwardly extending shelves configured to support the base portion perpendicularly relative to the rear wall when the base portion is attached to the rear wall.

11) The condensate drain cleaning apparatus of claim 1, wherein the first end of the elongated tube includes a first cap configured to removably attach to the mouth of the cleaning fluid container and the second end of the elongated tube includes a second cap configured to removably attach to the inlet of a condensate drain pipe.

12) The condensate drain cleaning apparatus of claim 11, wherein the first cap includes a first orifice in fluid communication with the first end of the elongated tube, and the second cap includes a second orifice in communication with the second end of the elongated tube.

13) The condensate drain cleaning apparatus of claim 11, wherein the drip chamber is disposed between the first end of the elongated tube and the flow regulation clamp.

14) The condensate drain cleaning apparatus of claim 13, wherein the flow regulation clamp comprises a flow regulation dial rotatably coupled to the elongated tube.

15) The condensate drain cleaning apparatus of claim 13, wherein the flow regulation clamp comprises a roller clamp.

16) The condensate drain cleaning apparatus of claim 3, wherein the flow regulation clamp comprises an electronic clamp.
